(19) United States
(12) Patent Application Publication
(10) Pub. No.: US 2015/0219564 A1
(43) Pub. Date: Aug. 6, 2015

(54) METHOD FOR OPTICALLY DETERMINING AT LEAST ONE ANALYTE IN A SAMPLE

(71) Applicant: Siemens Healthcare Diagnostics Products GmbH, Marburg (DE)

(72) Inventors: Frank Vitzthum, New City, NY (US); Herbert Schwarz, Lohra (DE); Anja Haude-Barten, Marburg (DE)

(73) Assignee: Siemens Healthcare Diagnostics Products GmbH, Marburg (DE)

(21) Appl. No.: 14/421,358

(22) PCT Filed: Jul. 23, 2013
(86) PCT No.: PCT/EP2013/065463

§ 371 Date: Feb. 12, 2015

(30) Foreign Application Priority Data
Aug. 15, 2012 (EP) 12180529.5

(51) Int. Cl. G01N 21/78

(52) U.S. Cl. CPC G01N 21/78

(57) ABSTRACT

The present invention relates to a method for optically determining at least one analyte in a sample, in which a deviation from a reference value or the reference curve is evaluated as an indication that the optical determination of the at least one analyte is corrupted by measurement artifacts.

### AREA OF THE INVENTION

The present invention relates to a method for optically determining at least one analyte in a sample, in which a deviation from a reference value or the reference curve is evaluated as an indication that the optical determination of the at least one analyte is corrupted by measurement artifacts.

### BACKGROUND OF THE INVENTION

In particular in clinical diagnostics, analytes in a sample are frequently detected optically with the aid of indicator dyes, i.e., dyes which react with the analyte to be detected, for example, while forming a complex and/or by way of a reaction in which the dye is converted from one form into another. In both cases, the dye changes its spectral properties, i.e., for example, its absorption characteristic or its fluorescence characteristic. The change of the spectral properties can therefore be used as a measure for the presence of an analyte.

However, the interaction of the dye with the analyte to be detected is frequently not completely specific. In such cases, the dye also reacts with other substances or substance classes contained in the sample, and also changes its spectral properties in this case. Furthermore, the analyte to be detected can also interact with other substances too, so that the bonding or the reaction with the dye is impaired.

A sample can also contain substances which do not necessarily react or interact with the analyte or the dye, but do absorb in the relevant wavelength ranges and therefore influence the detection reaction.

Materials or substances which interfere with determinations are also referred to hereafter as so-called interfering materials. The presence of such interfering materials can result in erroneous determinations of the analyte, so that the concentration or activity thereof in a sample is underestimated or overestimated. In particular in clinical diagnostics, this can result in incorrect findings and therefore an incorrect diagnosis.

This is problematic, for example, in the clinical determination of albumin, in particular in urine. The determination of albumin in urine is one of the most important and frequently used parameters in clinical chemistry. This applies both to the central laboratory and also to diagnostics on location (point-of-care). However, overall protein determinations in the urine or plasma also have clinical relevance. Furthermore, methods for determining proteins and the concentration thereof are of great general interest. For example, methods for protein determination are essential in the development and for process monitoring of protein purifications, and the determination of the protein content in a sample also plays a large role in fundamental research.

The specificity of the detection of analytes by means of suitable indicator dyes can be improved in that more specific dyes are developed. Parallel reactions of the dye are minimized in this manner. For example, bromcresol green or bromcresol purple is preferably used for the detection of albumin in urine. These dyes hardly react with other proteins. This reduces the risk of incorrect determination due to the presence of proteins other than albumin. In spite of the use of more specific dyes, however, incorrect determinations still occur as a result of the influence of interfering materials.

Another approach for reducing possible artifacts due to interfering materials is to measure simultaneously at two different wavelengths. Thus, for example, on the one hand, a wavelength can be selected at which the analyte-dependent changes of the optical properties of the indicator dye are maximal, and, on the other hand, a wavelength can be selected at which a reference measurement is carried out. For example, chromophores such as hemoglobin and bilirubin or turbidity induced by interfering materials can interfere. Therefore, for example, comparative measurements are carried out in the absorption range of hemoglobin and bilirubin at 540 nm or, to ascertain turbidity, in the long wavelength range, for example at 700 or 750 nm. If a specific limiting value is exceeded, this indicates turbidity or the influence of a chromophore. If the limiting value is exceeded, the determination is to be classified as possibly incorrect.

This approach also cannot entirely suppress artifacts due to interfering materials, and in addition corrupted measured values due to artifacts which are not suppressed are frequently not apparent to the user and he must therefore assume the incorrect measurement result to be correct. Furthermore, for example, chromophores can induce turbidity of the sample and thus corrupt the measurement result.

### BRIEF DESCRIPTION OF THE INVENTION

It is one object of the present invention to reduce the number of incorrect determinations of analytes. It is a further object of the present invention to increase the reproducibility of optical determinations of analytes. It is a further object of the present invention to also make those samples, which are contaminated at a specific probability, accessible to an analysis.

These objects are achieved by the features of the present set of claims. The dependent claims specify preferred embodiments. In this case, it is to be noted that the mentioned range specifications are to be understood as inclusive of the respective limiting values throughout.

### DETAILED DESCRIPTION OF THE INVENTION

According to the invention, a method for optically determining at least one analyte in a sample is provided, in which method at least one indicator dye is used which changes its optical properties at at least one given light wavelength (“measurement wavelength”) in dependence on the concentration of a given analyte.

In this case, in a step a) at least one optical property of the sample is determined at at least one measurement wavelength, and in a step b) at least one optical property of the sample is additionally determined at at least one further light wavelength (“reference wavelength”). Optionally, it can be provided that an arithmetically calculated value is ascertained in a step c) from the two measured values ascertained in steps a) and b).

Furthermore, it is provided, in a step d), to compare the measured value obtained in step b) by determining the at least one optical property of the sample at the reference wavelength—or, if present, the value arithmetically calculated in step c)—to a reference value or a reference curve which was ascertained on the basis of measured values (“calibration measured values”) which were determined upon measurement of at least one optical property of reference samples at the at least one measurement wavelength and the at least one reference wavelength. In this case, the reference samples and the sample contain(ed) at least one indicator dye and known concentrations of the analyte.

In a step e), a minimum deviation of the measured value which is obtained in step b) by determining the at least one optical property of the sample at the reference wavelength—or, if present, of the value arithmetically calculated in step c)—from the reference value or the reference curve is evaluated as an indication that the optical determination of the at least one analyte is corrupted by measurement artifacts.

It is important in the case of the mentioned method that the method steps identified with reference signs a)-e) in no way must be executed in the mentioned sequence. Those methods in which the sequence of the method steps is exchanged are also included in the protection of the present application.

The measurement wavelength is preferably selected so that the analyte-dependent changes of the optical properties of the indicator dye are maximal thereon.

To differentiate between reference value and reference curve, it is to be noted that a reference value can be used if an isosbestic wavelength is used as the reference wavelength. A reference curve is required if a non-isosbestic wavelength is used as the reference wavelength.

Fundamentally, two variants of the method are conceivable, which are both linked via the same idea according to the invention. In variant 1, measurements are carried out at measurement wavelength(s) and reference wavelength(s). A specific reference value results from the reference curve on the basis of the measurement wavelength. If an isosbestic point is used, a reference curve is not necessary. The measured value at a reference wavelength cannot deviate from this reference value beyond a specific amount, otherwise this is an indication of a measurement artifact. According to variant 2, measurements are carried out at measurement wavelength(s) and reference wavelength(s). Values are (arithmetically) calculated from the measured values of the measurement wavelength(s) and of the reference wavelengths. A similar procedure is used with a calibration curve or reference curve. The calculated values of the measurements are compared to those of the reference curve. A minimum deviation of the ascertained arithmetically calculated value from the reference value is evaluated as an indication of an artifact.

It is preferably provided in this case that the concentration of at least one analyte in the sample is determined during the optical determination.

The analyte is particularly preferably at least one biomolecule, preferably selected from the group containing proteins, peptides, amino acids, polysaccharides, oligosaccharides, or monosaccharides, polynucleic acids, oligonucleic acids, or mononucleic acids, or lipids.

Proteins are particularly preferred here. The protein albumin is preferred in particular, which is used, inter alia, for diagnosing proteinuria, from which a kidney insufficiency may be concluded. Thus, an albumin concentration>20 mg/L of urine indicates the beginning development of nephropathy and is an early marker for glomerular damage.

Furthermore, it is preferably provided that the optical properties to be determined of the indicator dye and/or of the sample relate to the absorption and/or extinction.

It is particularly preferably provided that the indicator dye is a dye selected from the group containing
Coomassie brilliant blue (CBB)
DIDNTB
HABA
bromcresol green (BCG)
bromcresol purple (BCP)
bromphenol blue (BPB)
tetrabromophenol blue (TBPB)
pyrogallol sulfonephthalein.

DIDNTB is bis-(3c,3²-diiodo-4c4²-dihydroxy-5c5′-dinitrophenyte)-3,4,5,6-tetrabromosulfone phthalein (DIDNTB). HABA is 2-(4c-hydroxyazobenzene) benzoic acid (HABA).

Further dyes which come into consideration are diphenylamine, DABA (3,5-diaminobenzoic acid dihydrochloride), orcinol, and anthracycline antibiotics such as adriamycin or mithramycin.

It is particularly preferably furthermore provided that the measurement artifact is caused by at least one interfering material. Such an interfering material either also reacts with the indicator dye, which thereupon changes its spectral properties, interacts with the analyte, or absorbs in the relevant wavelength ranges, and therefore influences the detection reaction.

The interfering materials can be entirely different substance classes, for example, low-molecular-weight organic compounds, detergents, heterocycles, or proteins. For example, detergents such as SDS and Triton X-100, heterocycles such as NAD, or organic compounds such as glycine and HEPES can corrupt protein determinations by means of Coomassie brilliant blue (CBB). The methods of albumin determination by bromcresol purple (BCP) can be interfered with by the presence of low-molecular-weight interfering materials such as the endogenic uremic toxin 3-carboxy-4-methyl-5-propyl-2-furanpropanoic acid (CMPF). Furthermore, chromophores contained in the sample, for example, hemoglobin or the degradation products thereof, such as bilirubin, can also act as interfering materials.

It is particularly preferably provided that the reference wavelength is an isosbestic wavelength with respect to the indicator dye.

An isosbestic wavelength is a wavelength at which the optical properties of an indicator dye in relation to the incident light do not change or only slightly change in dependence on the specific analyte—in contrast to the measurement wavelength at which the change of the optical properties of the indicator dye in dependence on the specific analyte is the maximum possible (and ideally also proportional). At an isosbestic wavelength, for example, in absorption measurements in the case of samples which only contain various concentrations of the specific analyte in addition to the indicator dye, no concentration-dependent absorption change is obtained, but rather always a more or less constant absorption, which is predominantly oriented to the concentration of the indicator dye. In this manner—presuming a given concentration of the indicator dye—a reference value may be measured, to which later concrete obtained measured values are compared. Specifically, if an absorption deviating from this value is measured, an artifact due to an interfering material may be concluded therefrom.

In this case, it is provided that to determine the question of whether a minimum deviation is present of the measured value obtained in step b) by determining the at least one optical property of the sample at the reference wavelength or, if present, of the value calculated arithmetically in step c) of the reference value, it is checked whether
the measured value or the arithmetically calculated value lies outside the single or multiple standard deviation of the reference value of the standard of the calibration series and/or
the sensitivity and/or specificity of the measured value or of the arithmetically calculated value lies outside given limiting values.

Furthermore, it is preferably provided that the reference wavelength with respect to the indicator dye is a wavelength at which the indicator dye has neither an absorption maximum nor an absorption minimum.

It is preferably provided in this case that the reference curve was determined by
interpolation and/or extrapolation,
linear regression, and/or
a second-order or higher polynomial
   of the calibration measured values obtained according to step d).

It is particularly preferably provided in this case that to determine the question of whether a minimum deviation is present of the measured value obtained in step b) by determining the at least one optical property of the sample at the reference wavelength or, if present, of the value calculated arithmetically in step c) of the reference value or the reference curve, it is checked whether
the measured value or the arithmetically calculated value lies outside a given confidence interval of the reference value or of the reference curve,
the measured value or the arithmetically calculated value lies outside an interval formed by interpolation or regression of the single or multiple standard deviation of the individual calibration measured values of the standard of the calibration series, and/or
the sensitivity and/or specificity of the measured value or of the arithmetically calculated value lies outside given limiting values.

In practice, the following procedure can be used in this case: Firstly, a calibration curve is prepared, in which for samples, which are free of interfering material, of known concentration, and which contain indicator dye, the absorption was measured at the reference wavelength and the measurement wavelength. The obtained values were plotted in comparison to one another in a coordinate system, and subsequently a linear regression is carried out and confidence intervals are calculated. Samples obtained in practice are now admixed in a similar manner with indicator dye and measured. Samples which contain interfering material which substantially influences the measurements and thus results in measurement artifacts, lie outside the confidence intervals and can therefore be identified as faulty. FIG. 4 shows the implementation of this method.

Furthermore, the single, double, or triple standard deviations of the calibration measured values could be used to establish a reference range. For this purpose, the calibration measured values are measured multiple times and mean value and standard deviation are determined. The corresponding value is added to the mean value or subtracted therefrom. The dependence of the values above the mean values and that of the values below the mean values on the absorption, for example, at 594 nm, or a corresponding parameter is described by a function, for example, a polynomial or a linear regression. This function then supplies the upper and lower references or limiting values. The implementation is performed similarly as shown in FIG. 4, with the difference that now the n-fold standard deviation is used instead of the confidence interval.

A further possibility for establishing limiting values is to establish the desired sensitivity or specificity of the method. As in almost all analytic or diagnostic methods, incorrect estimations also occur in the method according to the invention. It can occur that in the case of samples which do not contain interfering materials, a measurement artifact resulting from an interfering material is concluded (“false positive”), and/or that in the case of samples which contain interfering materials, these are not recognized (“false negative”).

The sensitivity of a method supplies the information about how many positive samples (i.e., samples which contain interfering material or even more special samples, which contain interfering material which corrupts the determination of the actual analyte beyond an acceptable amount) are recognized as such. In this case, the sensitivity of the method would identify the proportion of the samples having interfering material or measurement artifact related to interfering materials, which is correctly recognized among all measured samples having corresponding interfering material. This is reproduced by the equation

sensitivity=(detected samples having interfering material/total number of the measured samples having interfering material) (%).

The specificity of a method supplies a characteristic for how many false positives are to be expected. In this case, this means how many samples are classified as affected by interfering material incorrectly, although they are not impaired by interfering materials. This is reproduced by the equation

specificity=(samples in which no interfering material was detected/total number of the measured samples without interfering material) (%).

The sensitivity and specificity of the method can be established by the selection of limiting values. These can be adapted in dependence on the requirements for the sensitivity and specificity and from experiential values of the interfering materials to be expected in a sample collective. For example, calibration measured values for samples which are not contaminated with interfering material of various concentrations can be generated and compared to calibration measured values for samples which contain interfering materials. The limiting values for specificity and sensitivity are then established so that a clean discrimination between corrupted and non-corrupted samples is enabled.

Furthermore, it is preferably provided that the optical determination of the at least one analyte and/or the measurement of the optical properties of the reference sample is carried out in a container selected from the group including cuvette, micro-titration plate, test tube, slide, detection chip, etc.

### EXEMPLARY EMBODIMENTS

The following materials from the indicated companies were used for the experiments. Bovine serum albumin (BSA; A7030-50G; batch 124K0597) and nicotinamide adenine dinucleotide ((NAD), product number 43410; lot 42606158) were from Sigma (Taufkirchen, Germany). HEPES (catalog number 441475K; lot K35477084 647) was from BDH Chemical (Poole, UK). Triton X-100 (catalog number 1.08603.1000), glycine (catalog number 1.04201.1000; lot K34245201515) were from Merck (Darmstadt, Germany). The concentrate of the CBB reagent (protein assay; dye reagent concentrate) (catalog number 500-0006; lot number 105341) was from Bio-Rad (Munich, Germany). PS 96-well microplates (catalog number 655 101; lot 03 26 01 03; F-shape) were from Greiner Bio-one (Frickenhausen, Germany). The spectrophotometer Spectra Max Plus from Molecular Devices was used. Experiments were carried out as described hereafter:

An aqueous BSA stock solution having a concentration of 100 μg/mL was produced. BSA calibrators of 100, 80, 60, 40, 20, and 10 μg/mL were produced by corresponding dilutions with water. The calibrator without BSA was water. CBB solution was produced by 1:4 dilution of the CBB concentrate with water. 60 μL of sample were provided in a well of an MTP and 240 μL of CBB solution were added thereto. After approximately 10 minutes incubation at room temperature, spectrophotometric determinations were carried out. Spectra were generally recorded between 400-650 nm in steps of 2 μm. Triton X-100 is located in a special variant of the CBB solution. This reagent is to increase the sensitivity of protein determinations and was produced by admixing CBB solution with Triton X-100 so that the concentration of the Triton X-100 was 0.008% (v/v).

Corresponding interfering substance quantities were added to the BSA or water provided in the cavity and subsequently admixed with CBB solution. It is clear from FIG. 1 that the absorption maxima or absorption shoulders of the double-protonated and the single-deprotonated form are at approximately 650, 470, 310, and 270 nm. Isosbestic points at the transition of the double-protonated form into the single-deprotonated form are at approximately 550 and 340 nm. Upon a further increase of the pH value, a hypsochromic shift occurs, i.e., a shift into the shorter wave range due to the transition from the single-deprotonated form into the double-deprotonated form. This CBB anion has absorption maxima at approximately 580, 400, and 265 nm. Furthermore, the absorption shoulder increases in intensity at approximately 310 nm, to finally form a separate absorption band having a maximum in this wavelength range.

Isosbestic points at the transition of the single-deprotonated form into the double-deprotonated form are at approximately 530 and 330 nm. This transition is decisive in the bonding of the dye to proteins in the case of the use of typical buffer solution having a pH value of approximately 0.77.

### 1. Protein Determination Using CBB

The determination of the protein concentration is performed via a calibration, for example, via a calibration straight line. Absorption values of calibrators having known BSA concentrations are used to determine the BSA concentration or protein concentration in unknown samples. In the case of the protein determination by means of CBB, the absorption at 595 nm or the quotient of the absorptions at 595 and 470 nm (“initial ratio”) is generally used.

Table 1 shows the recovery of a predefined BSA concentration of 40 μg/mL or of a sample without BSA by means of absorption determination at 595 nm or the quotient calculation at 595 and 470 nm in the absence or presence of various substances of different concentration. Standard CBB was used in the experiments. It is clear that without interfering substances such as glycine, HEPES, SDS, Triton X-100, or NAD, the BSA concentration of a sample having a predefined BSA concentration of 40 μg/mL or that of a sample without BSA is recovered well. However, the presence of interfering substances results in coarse incorrect determinations.

TABLE 1

| | | Calculated | | | Calculated | |
|---|---|---|---|---|---|---|
| | | BSA | “Target” | | BSA | “Target” |
| | MW abs | concentration | BSA | MW abs | concentration | BSA |
| | 595/470 nm | [μg/mL] | [μg/mL] | 595 nm | [μg/mL] | [μg/mL] |
| Without | 1.29 | 38.72 | 40 | 0.84 | 44.60 | 40 |
| glycine | | | | | | |
| 0.1M | 1.72 | 61.23 | 40 | 1.08 | 75.68 | 40 |
| glycine | | | | | | |
| 0.2M | 4.08 | 182.24 | 40 | 1.34 | 109.14 | 40 |
| glycine | | | | | | |
| 0.4M | 12.23 | 600.01 | 40 | 1.17 | 87.56 | 40 |
| glycine | | | | | | |
| Without | 0.55 | 1.19 | 0 | 0.45 | −5.31 | 0 |
| glycine | | | | | | |
| 0.1M | 0.83 | 15.58 | 0 | 0.67 | 22.75 | 0 |
| glycine | | | | | | |
| 0.2M | 3.32 | 143.31 | 0 | 1.32 | 107.53 | 0 |
| glycine | | | | | | |
| 0.4M | 14.03 | 692.08 | 0 | 1.35 | 111.27 | 0 |
| glycine | | | | | | |
| Without | 1.27 | 37.89 | 40 | 0.83 | 43.79 | 40 |
| HEPES | | | | | | |
| 0.1M HEPES | 2.64 | 108.40 | 40 | 0.97 | 62.03 | 40 |
| 0.15M | 3.91 | 173.12 | 40 | 1.05 | 72.58 | 40 |
| HEPES | | | | | | |
| 0.2M HEPES | 6.21 | 291.52 | 40 | 1.10 | 79.09 | 40 |
| Without | 0.55 | 0.90 | 0 | 0.46 | −5.04 | 0 |
| HEPES | | | | | | |
| 0.1M HEPES | 1.50 | 49.81 | 0 | 0.74 | 31.87 | 0 |
| 0.15M | 3.19 | 136.27 | 0 | 1.05 | 71.88 | 0 |
| HEPES | | | | | | |
| 0.2M HEPES | 5.97 | 278.92 | 0 | 1.25 | 97.60 | 0 |
| Without SDS | 1.30 | 39.58 | 40 | 0.83 | 43.60 | 40 |
| 0.1% SDS | 1.30 | 39.31 | 40 | 0.60 | 13.06 | 40 |
| 0.2% SDS | 1.33 | 41.02 | 40 | 0.52 | 3.55 | 40 |
| 0.4% SDS | 1.42 | 45.72 | 40 | 0.37 | −15.58 | 40 |
| Without | 0.60 | 3.38 | 0 | 0.46 | −3.99 | 0 |
| SDS | | | | | | |
| 0.1% SDS | 1.24 | 36.31 | 0 | 0.72 | 29.15 | 0 |
| 0.2% SDS | 1.33 | 41.08 | 0 | 0.52 | 3.34 | 0 |
| 0.4% SDS | 1.42 | 45.56 | 0 | 0.37 | −16.56 | 0 |
| Without | 1.07 | 44.596 | 40 | 1.0014 | 54.976 | 40 |
| Triton | | | | | | |
| 0.05% | 3.15 | 195.637 | 40 | 1.831 | 153.738 | 40 |
| Triton | | | | | | |
| 0.1% | 9.19 | 633.231 | 40 | 2.6298 | 248.833 | 40 |
| Triton | | | | | | |
| 0.5% | 20.72 | 1468.769 | 40 | 2.5447 | 238.702 | 40 |
| Triton | | | | | | |
| Without | 0.43 | −1.517 | 0 | 0.4622 | −9.214 | 0 |
| Triton | | | | | | |
| 0.05% | 0.50 | 3.497 | 0 | 0.545 | 0.643 | 0 |
| Triton | | | | | | |
| 0.1% | 7.15 | 485.114 | 0 | 2.5668 | 241.333 | 0 |
| Triton | | | | | | |
| 0.5% | 15.73 | 1106.703 | 0 | 2.5177 | 235.488 | 0 |
| Triton | | | | | | |
| Without | 1.051 | 43.326 | 40 | 0.9444 | 48.190 | 40 |
| NAD | | | | | | |
| 0.055 μM | 1.159 | 51.115 | 40 | 0.8857 | 41.202 | 40 |
| NAD | | | | | | |
| 0.278 μM | 1.553 | 79.708 | 40 | 0.9301 | 46.488 | 40 |
| NAD | | | | | | |
| 0.55 μM | 2.380 | 139.622 | 40 | 0.8773 | 40.202 | 40 |
| NAD | | | | | | |
| Without | 0.462 | 0.627 | 0 | 0.522 | −2.095 | 0 |
| NAD | | | | | | |
| 0.055 μM | 2.759 | 167.097 | 0 | 1.6801 | 135.774 | 0 |
| NAD | | | | | | |
| 0.278 μM | 0.547 | 6.758 | 0 | 0.4232 | −13.857 | 0 |
| NAD | | | | | | |
| 0.55 μM | 0.752 | 21.680 | 0 | 0.4162 | −14.690 | 0 |
| NAD | | | | | | |

2. Protein Determination Using CBB in Combination with Triton X-100

In a specific variant of the protein determination by means of CBB, Triton X-100 is added to the reagent. This is to increase the sensitivity of the determination. Table 2 shows the recovery of a predefined BSA concentration of 40 μg/mL or of a sample without BSA by means of absorption determination at 595 nm or quotient calculation at 595 and 470 nm in the absence or presence of various substances of different concentration. CBB with a Triton X-100 concentration of 0.008% was used in the experiments. It is clear that without further interfering substances, the BSA concentration of a sample having a predefined PSA concentration of 40 μg/mL or that of a sample without BSA is well recovered. Although Triton X-100 is present in the reagent, the presence of further quantities of Triton X-100 in the sample can again result in coarse incorrect determinations.

TABLE 2

| | | Calculated | | | Calculated | |
|---|---|---|---|---|---|---|
| | | BSA | “Target” | | BSA | “Target” |
| | MW abs | concentration | BSA | MW abs | concentration | BSA |
| | 595/470 nm | [μg/mL] | [μg/mL] | 595 nm | [μg/mL] | [μg/mL] |
| Without | 0.98 | 35.82 | 40 | 0.85 | 40.65 | 40 |
| Triton | | | | | | |
| 0.02% | 6.56 | 393.92 | 40 | 2.45 | 129.92 | 40 |
| Triton | | | | | | |
| 0.05% | 12.62 | 782.32 | 40 | 2.94 | 161.54 | 40 |
| Triton | | | | | | |
| 0.1% | 16.55 | 1034.08 | 40 | 3.02 | 166.93 | 40 |
| Triton | | | | | | |
| Without | 0.46 | 2.50 | 0 | 0.49 | 4.45 | 0 |
| Triton | | | | | | |
| 0.02% | 5.85 | 348.21 | 0 | 2.40 | 127.10 | 0 |
| Triton | | | | | | |
| 0.05% | 12.46 | 771.82 | 0 | 2.90 | 159.24 | 0 |
| Triton | | | | | | |
| 0.1% | 14.06 | 874.68 | 0 | 2.88 | 158.04 | 0 |
| Triton | | | | | | |

Fundamentally, the samples having particularly high absorption values are already noteworthy per se. In the case of samples which exceed an absorption of X, a dilution is generally performed and measurement is performed once again, since the absorption behavior above this threshold no longer behaves linearly in relation to the concentration of the respective indicator.

Measurement artifacts caused by interfering materials can generally only be detected, however, if the absorption value thereof lies outside the value range which was established by prior calibration using samples of known content, wherein these calibration values must reflect the maximum or minimum analyte concentrations to be expected.

### DRAWINGS

FIG. 1: dependence of the spectrum of Coomassie brilliant blue (CBB) on the pH value of the medium.

Protein or albumin determinations using CBB are generally carried out at a wavelength of approximately 595 nm. The difference of the absorption between two forms of CBB, the free form and the protein-bound form, is greatest here. It is described that the dye bonds to proteins via van-der-Waals and hydrophobic interactions and in particular by means of interactions with basic amino acids, such as arginine, lysine, and histidine. The number of dye molecules should correlate with the number of positive charges of the proteins. Free amino acids, peptides, and low-molecular-weight proteins less than 3000 g per mole generally do not react with CBB.

Neglecting other influences on the spectral properties in the bonding of the dyes to proteins, it is presumed that the change of the spectral properties is accompanied in particular by a reaction which is mediated by proteins. A change of the proteolytic equilibrium of the dyes occurs due to the interaction with proteins. This protein dependent acid-base reaction is accompanied by a significant change of spectrophotometric properties of CBB.

CBB is present in the strongly acidic aqueous milieu as a double-protonated cation (AH₂⁺). In the case of CBB, a two-stage deprotonation can therefore occur. The pK values of these reactions are closely matched. CBB is deprotonated in this case from a red (470 nm) cation (AH₂⁺) having a single positive charge at pH 0.3, via a green (650 nm) neutral substance (AH), into a blue (595 μm) anion (A⁻) having a single negative charge at pH 1.3 in two steps.

The measurements were performed using a spectrophotometer employing quartz cuvettes. 3 mL of a Coomassie brilliant blue solution having a pH value of 0.76 were titrated step-by-step by adding 150 to 300 μL 1N sodium hydroxide solution to a pH value of 1.55. The temperature increased from 21 to 31° C. in this case. The sample was diluted by approximately 40%. Furthermore, 3 mL of a Coomassie brilliant blue solution having a pH value of 0.76 were acidified step-by-step by adding 150 to 200 μL 10 N hydrochloric acid solution to a pH value of 0.18. The temperature increased in this case from 21 to 29° C. The sample was diluted by approximately 23%. The measurements were performed approximately minutes after adding the sodium hydroxide solution or the hydrochloric acid solution, respectively. The influence of the temperature change is negligible. It can be seen well that the indicator reaction has isosbestic points or range in the range of approximately 340 nm and in the range of 520-520 nm. In general, 594 nm and/or 470 nm are used as the measurement wavelengths. Measurement is often also simultaneously or successively performed at both wavelengths and a quotient of both measured values is calculated (“initial ratio”). In one exemplary embodiment, 540 nm is used as the reference wavelength. This wavelength suggests itself in particular since devices which are typical in the branch frequently use filters, which enable measurements at the wavelength of 540 nm.

FIG. 2: recovery of samples with 0 and 40 mg/L BSA by means of absorption determination at 595 nm in the absence or presence of glycine.

Firstly, a calibration curve was prepared using known concentrations of BSA (CBB reagent, 595 nm). It results in this case that the ratio between the absorption at 595 nm and the BSA concentration is not entirely linear. The target values (without glycine) for 0 mg/L and 40 mg/L BSA are marked with rectangles. By adding 0.1 M (triangle), 0.2 M (star), and 0.4 M glycine (diamond), the absorption values increase both in the sample without BSA and also in the sample with BSA. The presence of 0.1 glycine already results in a strong deviation of the target value at 0 and 40 mg/L BSA. For the case in which the concrete measured values are significantly outside the absorption range to be expected on the basis of the calibration curve, a measurement artifact due to interfering materials can be concluded. For the case in which the concrete measured values do not lie significantly outside the absorption range to be expected on the basis of the calibration curve, a measurement artifact due to interfering materials is not noticed.

FIG. 3: recovery of samples with 0 and 40 mg/L BSA by means of double determination at 595 nm and 470 nm (measurement wavelengths) in the absence or presence of glycine.

FIG. 3 shows similar results as FIG. 2. The target values (without glycine) are marked with rectangles. By adding 0.1 M (triangle), 0.2 M (star), and 0.4 M glycine (diamond), the quotient abs [595/470] is elevated increasingly both in the sample without BSA and also in the sample with BSA. Even the presence of 0.1 glycine results in a strong deviation of the target value at 0 and 40 mg/L BSA. In contrast to FIG. 2, in FIG. 3 double determinations were carried out at 595 nm and 470 nm both for the calibration and also for the concrete measurements and expressed as the quotient abs [595/470]. In this case, in contrast to the determination only at 595 nm, a linear ratio results between the quotients and the BSA concentration.

FIGS. 2 and 3 make it clear that the fact that a concrete measured value lies within the absorption range to be expected on the basis of a calibration curve does not offer a possibility of precluding erroneous measurements. If, according to the invention, however, a measurement is carried out in addition at at least one reference wavelength (see below), erroneous measurements may be excluded better.

FIG. 4: ratio between absorption at 440 nm (reference wavelength) and absorption at 594 nm (measurement wavelength, which is used to determine the BSA concentration) and the influence of the interfering material glycine.

In FIG. 4, firstly a calibration curve was prepared, in which for samples free of interfering material of known concentration (CBB +0, 10, 20, 30, 60, 80, and 100 μg/mL BSA), the absorption was measured at 440 nm (reference wavelength) and 594 nm (measurement wavelength). The values were plotted in comparison to one another, and subsequently a linear curve fit was carried out and confidence intervals were calculated. Subsequently, contaminated samples were intentionally measured in a similar manner at 440 nm (reference wavelength) and 594 nm (measurement wavelength). The samples which contained interfering material (0.1 M glycine) (circle) lie outside the confidence intervals and are therefore correctly identified as erroneous.

The confidence intervals are the 95% confidence range or the 95% prediction range, which was determined by means of a linear regression (y=−0.37x+1.12; R=−0.99687).

The upper 95% prediction range can be described by a second-order polynomial (Y=A+B₁x+B₂x²) with the equation y=1.15664−0.40253x+0.01693 x². The lower 95% prediction range can be described by a second-order polynomial with the equation y=1.08494−0.34598x+0.01693 x².

For the sake of simplicity, in this case the upper 95% prediction range can be described approximately well by a linear regression (Y=A+B′ X) with the equation y=−0.3729x+1.145.

For the lower 95% prediction range, a linear regression supplies the equation y=−0.3756x+1.096. The correlation coefficients R of both linear regressions are −0.99993.

It is decisive that values which lie above or below the corresponding reference ranges indicate erroneous determinations. This is clearly shown in the described exemplary embodiment with the samples having interfering factor (for example, 0.1 M glycine). The erroneous determinations of 22.75 or 75.68 μg/mL BSA instead of 0 and 40 μg/mL BSA (see Table 1) are recognized.

If the above-mentioned reference range is selected, for example, with an absorption of 0.72 at 594 nm of the sample without BSA and 0.1 M glycine, with the reference algorithm based on the linear regression, the absorption at 440 nm should be between

y=−0.3729*0.72+1.145=0.877 and

y=−0.3756*0.72+1.096=0.826.

However, this is not the case with an absorption value at 440 nm of 0.7.

It is also conceivable that other algorithms are used. For example, the single, double, or triple standard deviations of the individual calibrators of the standard of the calibration series could be used to establish a reference range. The corresponding value is added to the mean value or subtracted therefrom. The dependence of the values above the mean values and that of the values below the mean values on the absorption, for example, 594 nm, or a corresponding parameter is described by a function, for example, a polynomial or a linear regression. This function then supplies the upper and lower references or limiting values.

FIG. 4: ratio between absorption at 440 nm (reference wavelength) and quotient abs [595/470] (initial ratio of two measurement wavelengths) in the absence or presence of the interfering material glycine.

FIG. 5 shows similar results as FIG. 4, however, for the preparation of the calibration curve here, the absorption at 440 nm (reference wavelength) was plotted against the quotient abs [595/470] (initial ratio of two measurement wavelengths). The samples which contain interfering material (0.1 M glycine) (circle) also lie outside the confidence intervals here and are therefore correctly identified as erroneous.

FIG. 6: dependence of the absorption at an isosbestic wavelength 530 nm on the BSA concentration and influence of different Triton X-100 concentrations.

The Triton X-100 concentrations were 0% (▴), 0.02% (*), 0.05% (∘), and 0.1% (⋄). Coomassie brilliant blue (CBB) was used, which contains 0.008% Triton X-100. No Triton X-100 was in the samples, the measurement results of which are shown with triangles. The error bars illustrate the single standard deviation of a triple determination. A linear regression was carried out and a prediction range of 95% was ascertained. This means that 95% of the values to be expected lie within this prediction range.

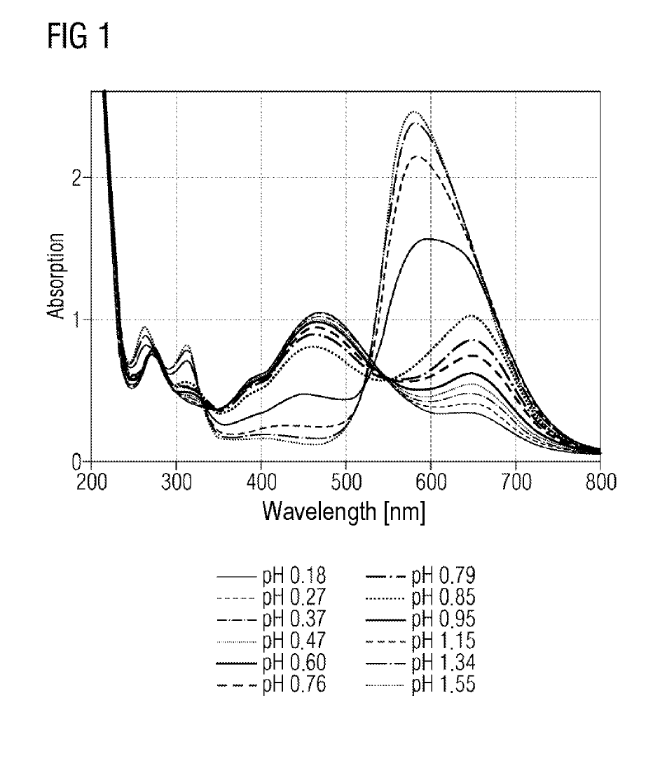

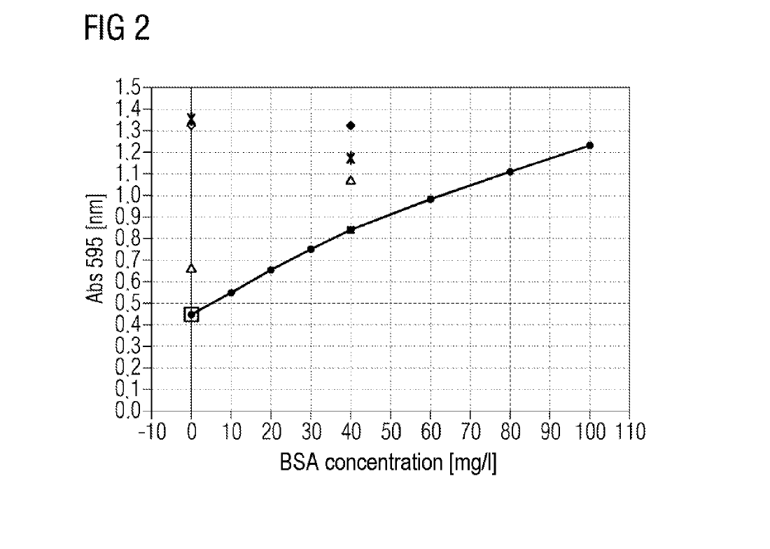

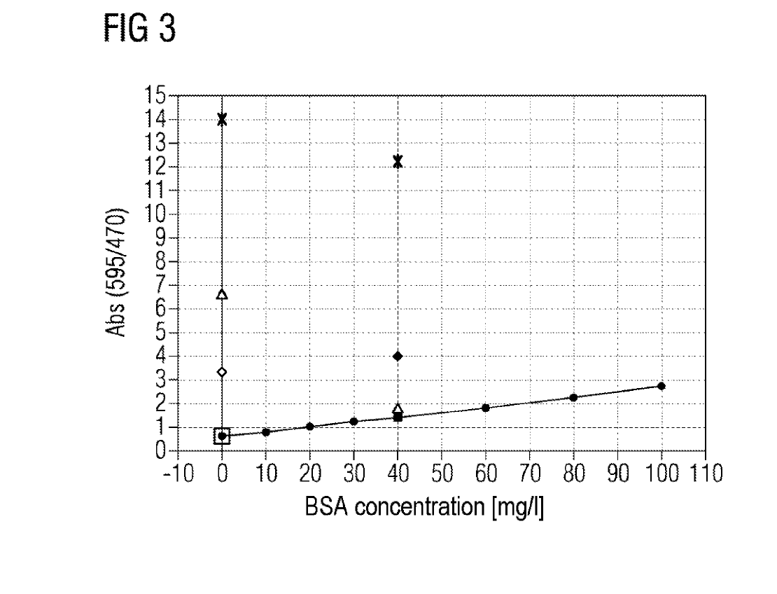

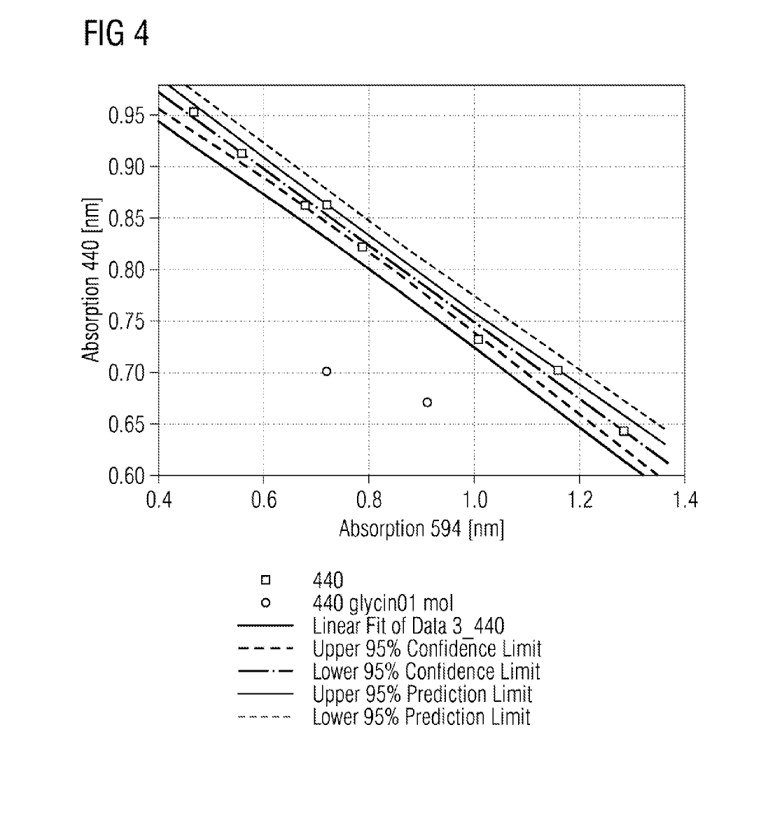

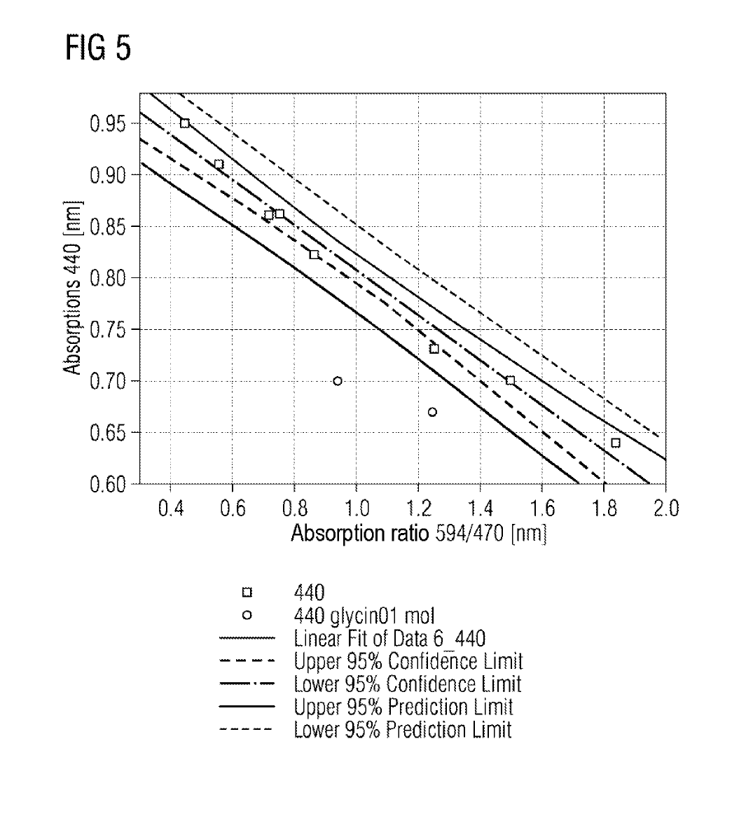

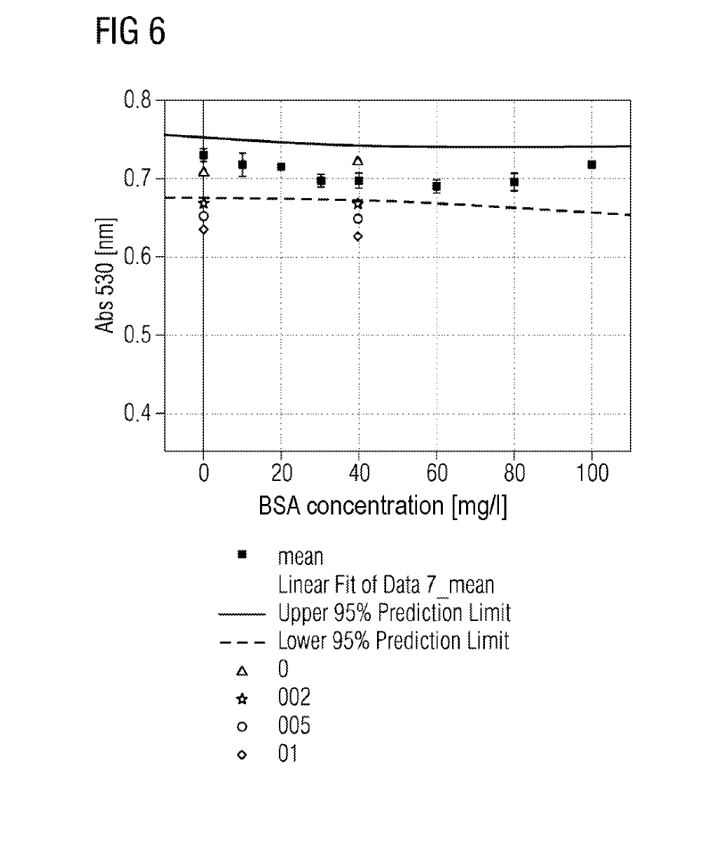

As is recognizable in FIG. 1, 530 nm is an isosbestic wavelength for Coomassie brilliant blue (CBB), i.e., a wavelength at which the absorption of CBB in relation to the incident light does not change in dependence on bound protein. In contrast to 440 nm, for example, a concentration-dependent absorption change is thus not obtained at 530 nm with samples which only contain various concentrations of BSA in addition to CBB, but rather always a more or less constant absorption which is predominantly oriented to the concentration of the indicator dye CBB and is approximately 0.675 in the present example. Samples which are contaminated with interfering materials such as Triton X-100 have, at equal CBB concentration, a deviation from this value, which in the present case lie above the minimum deviation determined by the prediction range of 95% and are therefore evaluated as an indication that the optical determination is corrupted by measurement artifacts.

The teaching according to the invention may thus be implemented, as recognizable above, both
a) using a reference value (specifically when this was measured at given indicator dye concentration at an isosbestic wavelength), and also
b) using a reference curve (specifically when this was measured at given indicator dye concentration at a non-isosbestic wavelength).

The selection of whether measurement is performed at an isosbestic wavelength or a non-isosbestic wavelength is dependent, inter alia, on the measurement wavelengths provided by the respective measuring device.

1. A method for optically determining at least one analyte in a sample, in which method at least one indicator dye is used which changes at least one optical property at at least one given light wavelength (“measurement wavelength”) in dependence on the concentration of a given analyte, wherein
a) at least one optical property of the sample is determined at at least one measurement wavelength,
b) at least one optical property of the sample is additionally determined at at least one further light wavelength (“reference wavelength”), and
c) optionally an arithmetically calculated value is ascertained from the two measured values ascertained in steps a) and b),
wherein
d) the measured value obtained in step b) by determining the at least one optical property of the sample at the reference wavelength or, if present, the value arithmetically calculated in step c) is compared to a reference value or a reference curve which was ascertained on the basis of measured values (“calibration measured values”) which were determined upon measurement of at least one optical property of reference samples at the at least one measurement wavelength and the at least one reference wavelength, wherein the reference samples and the sample contain at least one indicator dye and known concentrations of the analyte,
e) and wherein a minimum deviation of the measured value obtained in step b) by determining the at least one optical property of the sample at the reference wavelength or, if present, of the value arithmetically calculated in step c) from the reference value or the reference curve is evaluated as an indication that the optical determination of the at least one analyte is corrupted by measurement artifacts.

2. The method as claimed in claim 1, wherein the concentration of at least one analyte in the sample is determined during the optical determination.

3. The method as claimed in claim 1, wherein the analyte is at least one biomolecule, preferably selected from the group containing proteins, peptides, amino acids, polysaccharides, oligosaccharides, or monosaccharides, polynucleic acids, oligonucleic acids, or mononucleic acids, or lipids.

4. The method as claimed in claim 1, wherein the optical properties to be determined of the indicator dye and/or of the sample relate to absorption and/or extinction.

5. The method as claimed in claim 1, wherein the indicator dye is a dye selected from the group containing
Coomassie brilliant blue (CBB)
DIDNTB
HABA
bromcresol green (BCG)
bromcresol purple (BCP)
bromphenol blue (BPB)
tetrabromophenol blue (TBPB), and/or
pyrogallol sulfonephthalein.

6. The method as claimed in claim 1, wherein the measurement artifact is caused by at least one interfering material.

7. The method as claimed in claim 1, wherein the reference wavelength is an isosbestic wavelength with respect to the indicator dye.

8. The method as claimed in claim 1, wherein the reference wavelength with respect to the indicator dye is a wavelength at which the indicator dye has neither an absorption maximum nor an absorption minimum.

9. The method as claimed in claim 1, wherein the reference curve was determined by
interpolation and/or extrapolation,
linear regression, and/or
curve fit by means of a second-order or higher polynomial of the calibration measured values obtained according to step d).

10. The method as claimed in claim 1, wherein to determine the question of whether a minimum deviation is present of the measured value obtained in step b) by determining the at least one optical property of the sample at the reference wavelength or of the value calculated arithmetically in step c) of the reference value or the reference curve, it is checked whether
the measured value or the arithmetically calculated value lies outside a given confidence interval of the reference value or of the reference curve,
the measured value or the arithmetically calculated value lies outside an interval formed by interpolation or regression of the single or multiple standard deviation of the individual calibration measured values of the standard of the calibration series, and/or
the sensitivity and/or specificity of the measured value or of the arithmetically calculated value lies outside given limiting values.

11. The method as claimed in claim 1, wherein the optical determination of the at least one analyte and/or the measurement of the optical properties of the reference sample is carried out in a container selected from the group including cuvette, micro-titration plate, test tube, slide, and detection chip.

12. A device for optically determining at least one analyte in a sample, wherein said device is implemented in the method in claim 1.
